(19) United States
(12) Patent Application Publication
(10) Pub. No.: US 2021/0280938 A1
(43) Pub. Date: Sep. 9, 2021

(54) CELL ROLL AND METHOD FOR MANUFACTURING SAME

(71) Applicant: Maxell Holdings, Ltd., Kyoto (JP)

(72) Inventors: Takahiro FURUTANI, Otokuni-gun, Kyoto (JP); Yasuhiro NAKA, Otokuni-gun, Kyoto (JP)

(73) Assignee: Maxell Holdings, Ltd., Kyoto (JP)

(21) Appl. No.: 17/256,529

(22) PCT Filed: Jul. 12, 2019
(86) PCT No.: PCT/JP2019/027733

§ 371 Date: Dec. 28, 2020

(30) Foreign Application Priority Data
Jul. 20, 2018 (JP) 2018-136561

(51) Int. Cl. H01M 50/244; H01M 50/209; H01M 12/06; H01M 50/534

(52) U.S. Cl. CPC H01M 50/244; H01M 50/534; H01M 12/06; H01M 50/209

(57) ABSTRACT

A cell roll disclosed in the present application includes a sheet-type continuous body including a long sheet-type outer case body and a plurality of power generation elements. The sheet-type outer case body includes a resin film. The power generation elements are individually sealed in the sheet-type outer case body. The power generation elements are located side by side in the longitudinal direction of the sheet-type outer case body. Each of the power generation elements includes a positive electrode, a negative electrode, a separator, and an electrolyte. The sheet-type outer case body and the power generation elements form individual cells. The sheet-type continuous body is wound in a spiral fashion.

### TECHNICAL FIELD

The present application relates to a cell roll from which sheet-type cells with a high degree of freedom in use can be provided with high productivity, and a method for producing the cell roll.

### BACKGROUND ART

In recent years, there is a growing demand for a sheet-type cell having a sheet-type outer case that includes a resin film as a constituent material. Such a sheet-type cell covers a wide range of applications, including the use of large cells, e.g., for power sources of industrial devices and the use of small cells, e.g., for power sources of electronic devices such as smartphones.

The outer case of the sheet-type cell is typically made of a laminated film of metal foil such as aluminum and a thermoplastic resin. Patent Document 1 discloses that this configuration can provide an air cell with a high degree of freedom in shape and excellent discharge characteristics.

Patent Documents 2 and 3 disclose the use of a printing process to form cell members in the production of the sheet-type cell. In the printing process, e.g., a carbon coating is applied to the surface of a sheet-type base material (outer case member) such as a resin film to form a current collecting layer. Then, a coating in which an active material is dispersed is applied to the surface of the current collecting layer. Thus, a positive electrode and a negative electrode are integrated with the respective outer case members, thereby providing the cell members.

Patent Document 4 discloses an electrochemical device that includes four or more electrodes and separators that are alternately stacked with each other. In order to reduce a positional deviation when the electrochemical device is produced by a roll-to-roll method each of the electrodes has projections on the end portions in the width direction, and the projections of different devices are fixed with connection straps. The devices thus connected are separated into individual devices so that the assembly of the electrochemical device is completed.

### PRIOR ART DOCUMENTS

### Patent Documents

Patent Document 1: JP 2004-288571 A

Patent Document 2: JP 2012-209048 A

Patent Document 3: JP 2005-527093 A

Patent Document 4: JP 2009-32727 A

### DISCLOSURE OF INVENTION

### Problem to be Solved by the Invention

Unlike dry cells that are generally distributed, sheet-type cells do not have common specifications of properties (voltage, capacity, etc.), and in many cases user needs are different. Therefore, various types of cells should be produced to address the user needs, which may cause a loss of productivity of the sheet-type cells. On the other hand, if the sheet-type cells to be produced are limited to particular characteristics, the productivity of these sheet-type cells can be improved, but the user convenience will be reduced because of constraints on the specification of equipment to be used.

The present application has been made in view of the circumstances as described above, and provides a cell roll from which sheet-type cells with a high degree of freedom in use can be provided with high productivity, and a method for producing the cell roll.

### Means for Solving Problem

A cell roll disclosed in the present application includes a sheet-type continuous body including a long sheet-type outer case body and a plurality of power generation elements. The sheet-type outer case body includes a resin film. The power generation elements are individually sealed in the sheet-type outer case body. The power generation elements are located side by side in the longitudinal direction of the sheet-type outer case body. Each of the power generation elements includes a positive electrode, a negative electrode, a separator, and an electrolyte. The sheet-type outer case body and the power generation elements form individual cells. The sheet-type continuous body is wound in a spiral fashion.

The cell roll disclosed in the present application can be produced, e.g., by a method including the following: forming the negative electrode by supplying metal foil such as zinc alloy foil with a thickness of 10 μm or more and 500 μm or less and cutting the metal foil to a predetermined shape having a lead; forming the sheet-type continuous body by sealing power generation elements in sequence in the sheet-type outer case body, each of the power generation elements including the electrolyte and a layered body in which the positive electrode, the separator, and the negative electrode are sequentially stacked; and winding the sheet-type continuous body in a spiral fashion to form a cell roll.

### Effects of the Invention

The present invention can provide a cell roll from which sheet-type cells with a high degree of freedom in use can be provided with high productivity, and a method for producing the cell roll.

### BRIEF DESCRIPTION OF DRAWING

FIG. 1 is a plan view schematically illustrating an example of a sheet-type continuous body of cells that constitutes a cell roll of an embodiment.

FIG. 2 is a cross-sectional view taken along the line I-I in FIG. 1.

FIG. 3 is a perspective view schematically illustrating an example of a cell roll of an embodiment.

### DESCRIPTION OF THE INVENTION

An embodiment of a cell roll disclosed in the present application will be described. The cell roll of this embodiment includes a sheet-type continuous body including a long sheet-type outer case body and a plurality of power generation elements. The sheet-type outer case body includes a resin film. The power generation elements are individually sealed in the sheet-type outer case body. The power generation elements are located side by side in the longitudinal direction of the sheet-type outer case body. Each of the power generation elements includes a positive electrode, a negative electrode, a separator, and an electrolyte. The sheet-type outer case body and the power generation elements form individual cells. The sheet-type continuous body is wound in a spiral fashion.

Hereinafter, the cell roll of this embodiment will be described with reference to the drawings.

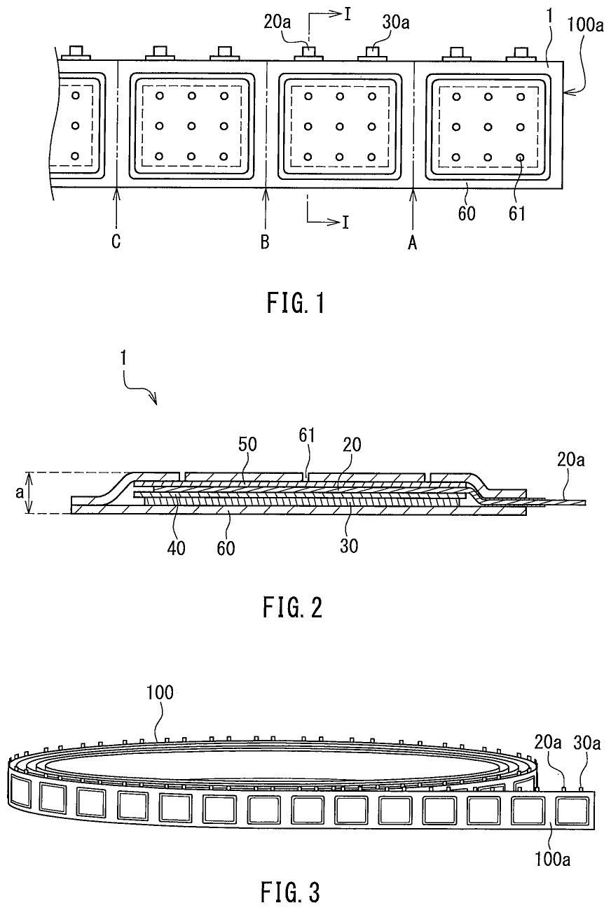

FIGS. 1 and 2 schematically illustrate an example of the sheet-type continuous body of cells that constitutes the cell roll of this embodiment. FIG. 1 is a plan view of the sheet-type continuous body of cells. FIG. 2 is a cross-sectional view taken along the line I-I in FIG. 1. The cross-sectional view also represents a cross section of each cell (sheet-type cell) that is cut from the sheet-type continuous body of cells.

A sheet-type continuous body 100a of cells is an example of a body including a plurality of air cells. In FIG. 1, a boundary between air cells 1 in the sheet-type continuous body 100a is indicated by an alternate long and two short dashes line.

In the sheet-type continuous body 100a, the air cells 1 share a long sheet-type outer case body 60 including a resin film. The air cells 1 are located in a row in the longitudinal direction of the sheet-type continuous body 100a. The sheet-type outer case body 60 has portions where the power generation elements are located, and the periphery of each of the portions is sealed by, e.g., heat sealing. Consequently, the individual air cells 1 can be separated from the adjacent air cells. The power generation elements are individually sealed in the sheet-type outer case body 60. The sheet-type outer case body 60 and the power generation elements form the individual cells.

In each of the air cells 1, as shown in FIG. 2, a positive electrode 20, a negative electrode 30, a separator 40, and an electrolyte (not shown), which constitute the power generation element, are contained in the sheet-type outer case body 60. The positive electrode 20 is connected to a positive electrode external terminal 20a, e.g., via a lead in the air cell 1. Although not shown in FIG. 2, the negative electrode 30 is also connected to a negative electrode external terminal 30a, e.g., via a lead in the air cell 1.

The positive electrode of the air cell may have a structure including, e.g., a catalyst layer and a current collector, as will be described later. For the purpose of brevity, the individual layers of the positive electrode 20 are not distinguished from each other in FIG. 2. In FIG. 1, a dotted line indicates the size of the catalyst layer of the positive electrode 20 contained in the sheet-type outer case body 60.

The sheet-type outer case body 60 has a plurality of air holes 61 in the side where the positive electrode 20 is provided so as to take air into the positive electrode. Moreover, a water repellent membrane 50 is located on the inner surface of the sheet-type outer case body 60 to prevent leakage of the electrolyte through the air holes 61.

The sheet-type continuous body 100a shown in FIG. 1 is wound in a spiral fashion to form a cell roll. FIG. 3 is a perspective view schematically illustrating the cell roll of this embodiment. For the purpose of brevity, the positive electrode external terminal 20a and the negative electrode external terminal 30a of each of the cells in the cell roll 100 are not shown in FIG. 3, except for the cells that are located substantially in the outermost circumference.

In the cell roll of this embodiment, the cells of the sheet-type continuous body share the long sheet-type outer case body. Each of the cells can be used by drawing the sheet-type continuous body from the cell roll and cutting it at the boundary between the cells (e.g., the portions of the sheet-type continuous body near the vertical alternate long and two short dashes lines A, B, and C in FIG. 1).

Depending on the intended use of the cell, the voltage and capacity of each cell may be insufficient. In such a case, when the sheet-type continuous body is drawn from the cell roll and divided into separate cells, the sheet-type outer case body may be cut so that a continuous series of cells is provided as a unit that would meet the required voltage and capacity. For example, if the voltage and capacity corresponding to those of two cells of the sheet-type continuous body are required, the sheet-type outer case body 60 will be cut along the line represented by B in FIG. 1. This can result in a unit in which two cells 1, located on the right side of FIG. 1, are contained in one sheet-type outer case. If the voltage and capacity corresponding to those of three cells of the sheet-type continuous body are required, the sheet-type outer case body 60 will be cut along the line represented by C in FIG. 1. This can result in a unit in which three cells 1, located on the right side of FIG. 1, are contained in one sheet-type outer case.

In order to facilitate the cutting of the sheet-type continuous body, it may be processed to have, e.g., perforations between the cells (e.g., the portions of the sheet-type continuous body near the vertical alternate long and two short dashes lines A, B, and C in FIG. 1) or cuts formed in the edge, so that the individual cells are configured to be easily cut off. The unit thus obtained may be used as a cell pack by electrically connecting the cells, e.g., in such a way that necessary wiring is applied directly to the cells or incorporated into the applicable device.

As described above, the cell roll of this embodiment makes it easy to provide a cell or a series of cells (single cell or cell pack) having the voltage and capacity required by the user. Moreover, there is no need to use another outer case for packing each single cell when a cell pack is formed. Thus, the cell roll of this embodiment allows sheet-type cells with a high degree of freedom in use to be provided with high productivity.

In this embodiment, the sheet-type continuous body of cells is rolled up to form the cell roll. Therefore, the cell roll can be efficiently produced by a so-called roll-to-roll method. Specifically, the method can achieve continuous production of the cell roll as follows. For example, two rolls of rein film constituting the sheet-type outer case body are used. First, a positive electrode, a separator, a negative electrode, etc. are sequentially stacked on the resin film drawn from one of the two rolls, on top of which the resin film drawn from the other roll is placed. This layered body includes the positive electrode, the separator, and the negative electrode that are disposed between the two resin films. Then, the outer edge of the layered body is heat-sealed while a part of it is left open. An electrolyte is injected through the remaining opening, followed by heat sealing. Subsequently, each cell is sealed so that the sheet-type continuous body of cells is obtained. The sheet-type continuous body is wound in a spiral fashion, which results in the cell roll. In this embodiment, each cell does not need to be packaged after the sheet-type continuous body has been divided into cells. Thus, the cell roll of this embodiment has high productivity. For this reason, the above method also can improve the productivity of the sheet-type cells obtained from the cell roll.

An air cell generates electricity by taking air from the outside into the positive electrode. Therefore, air holes are provided in the outer case of the air cell. If air enters the positive electrode before using the air cell, the air cell will be self-discharged. To deal with this issue, it is common practice for a normal air cell having an outer can to prevent air from entering the positive electrode during storage by closing the air holes with a seal attached to the portion of the outer can where the air holes are provided. Such a cell is used after removal of the seal. On the other hand, when an air cell has a sheet-type outer case, since the strength of the sheet-type outer case is low, the seal may not be removed smoothly and the sheet-type outer case may be damaged.

However, in the cell roll of this embodiment, the sheet-type continuous body composed of the air cells is wound in a series of loops, and the air holes of the individual air cells in each loop are covered with the sheet-type outer case body of the corresponding air cells in the next adjacent loop. This configuration can block the inflow of air to some extent. Thus, the storage properties of the air cells can be improved even without the use of the seal, as described above. Accordingly, the sheet-type outer case would be prevented from being damaged upon the removal of the seal. Moreover, the above configuration can save the trouble of removing the seal.

The sheet-type continuous body is preferably wound so that the air holes of the individual air cells face inward (i.e., to the winding center). This is because the air holes of the air cells in the outermost loop can also be closed.

The sheet-type continuous body of the cell roll is an aggregate of cells having the sheet-type outer case body. Although the thickness of the sheet-type continuous body can be reduced, the portions including the power generation elements become thicker than those including only the sheet-type outer case body. Thus, if the sheet-type continuous body is very long, there is a possibility that some air holes cannot be properly closed due to the uneven thickness. In such a case, the sheet-type continuous body is preferably wound with a resin sheet being on the surface of the sheet-type continuous body where the air holes are provided, thereby forming the cell roll. This configuration can properly close the air holes by the action of the resin sheet, and therefore can improve the storage properties of the cells even if the sheet-type continuous body is very long.

The resin sheet that is to be wound together with the sheet-type continuous body is preferably, e.g., a film made of polyolefins such as polyethylene and polypropylene, or nylon. Moreover, to reduce the permeability of the resin sheet for oxygen or moisture and further improve the storage properties of the cells, a sheet made of resin with low gas permeability such as an ethylene-vinyl alcohol copolymer and a resin sheet including a metal layer are also preferably used. The resin sheet including a metal layer may be, e.g., an aluminum laminated film having an aluminum vapor-deposited layer. The thickness of the resin sheet is preferably 10 to 200 μm.

The resin sheet is pressed by the adjacent sheet-type outer case body of the air cells, and thus can be brought into close contact, to some extent, with the surface of the sheet-type continuous body where the air holes are provided, even without the need for an adhesive layer for bonding the resin sheet with the sheet-type outer case body. This also can prevent damage to the sheet-type outer case when the seal is used, as described above.

The length of the sheet-type continuous body of the cell roll is not particularly limited and is preferably 10 m or more in view of the merit of being able to ship the sheet-type continuous body in a rolled-up state. Moreover, the length of the sheet-type continuous body is preferably 1000 m or less in order to prevent the cell roll from becoming too large and difficult to handle.

In the cell roll, if the diameter of the innermost circumference is too small, it becomes difficult to wind the sheet-type continuous body of cells, and particularly the cells located near the winding center are likely to be damaged. Therefore, from the viewpoint of ease of winding of the sheet-type continuous body and maintaining the reliability of the individual cells of the sheet-type continuous body, the diameter of the winding shaft (winding core) (i.e., the diameter of the innermost circumference of the wound sheet-type continuous body) is preferably 70 mm or more.

The cells in the cell roll of this embodiment may be, e.g., cells including as the electrolyte an electrolyte solution that is an aqueous solution containing water as a solvent (such as alkaline cells (alkaline primary cells and alkaline secondary cells), manganese cells, and air cells). They may also be cells including as the electrolyte a non-aqueous electrolyte containing a non-aqueous solvent (such as non-aqueous electrolyte cells (non-aqueous electrolyte primary cells and non-aqueous electrolyte secondary cells)).

Hereinafter, the power generation elements of the cells in the cell roll of this embodiment will be described by taking an air cell as an example.

<Positive Electrode>

The positive electrode (air electrode) of an air cell has a catalyst layer. For example, the positive electrode with a laminated structure of the catalyst layer and a current collector may be used.

The catalyst layer may contain, e.g., a catalyst and a binder.

Examples of the catalyst of the catalyst layer include the following: silver; platinum metals or alloys thereof, transition metals; platinum/metal oxides such as Pt/IrO₂; perovskite oxides such as La₁₋ₓCaₓCoO₃; carbides such as WC; nitrides such as Mn₄N; manganese oxides such as manganese dioxide; and carbon (including, e.g., graphite, carbon black (acetylene black, Ketjenblack, channel black, furnace black, lamp black, thermal black, etc.), charcoal, and activated carbon). These catalysts may be used alone or in combinations of two or more.

The heavy metal content in the catalyst layer is preferably 1% by mass or less. The sheet-type cell of this embodiment can be torn, e.g., by hand and easily broken for disposal. When the positive electrode has the catalyst layer with such a low heavy metal content, the environmental impact can be reduced even if the cell is disposed of without any special treatment.

In the present specification, the heavy metal content in the catalyst layer can be measured by X-ray fluorescence analysis. For example, the measurement can be performed using an X-ray fluorescence analyzer “ZSX100e” manufactured by Rigaku Corporation under the following conditions: excitation source, Rh 50 kV and analysis area, φ 10 mm.

Thus, catalysts containing no heavy metal are recommended as the catalyst of the catalyst layer, and the above carbon is more preferred.

In terms of further improving the reactivity of the positive electrode, the specific surface area of the carbon that is used as the catalyst is preferably 200 m²/g or more, more preferably 300 m²/g or more, and further preferably 500 m²/g or more. In the present specification, the specific surface area of the carbon is determined by a BET method in accordance with JIS K 6217. For example, the specific surface area of the carbon can be measured with a specific surface area measuring device (“Macsorb HM model-1201” manufactured by Mountech Co., Ltd.) based on a nitrogen adsorption method. The upper limit of the specific surface area of the carbon is usually about 2000 m²/g.

The content of the catalyst in the catalyst layer is preferably 20 to 70% by mass.

Examples of the binder of the catalyst layer include fluorocarbon resin binders such as PVDF, PTFE, copolymers of vinylidene fluoride, and copolymers of tetrafluoroethylene (including, e.g., a vinylidene fluoride-hexafluoropropylene copolymer (PVDF-HFP), a vinylidene fluoride-chlorotrifluoroethylene copolymer (PVDF-CTFE), a vinylidene fluoride-tetrafluoroethylene copolymer (PVDF-TFE), and a vinylidene fluoride-hexafluoropropylene-tetrafluoroethylene copolymer (PVDF-HFP-TFE)). Among them, polymers of tetrafluoroethylene (PTFE) or copolymers of tetrafluoroethylene are preferred, and PTFE is more preferred. The content of the binder in the catalyst layer is preferably 3 to 50% by mass.

The positive electrode having the catalyst layer can be produced by, e.g., mixing the above catalyst, binder, or the like with water, rolling the mixture between rotating rolls, and bringing the rolled material into close contact with the current collector. There may be another way of producing the positive electrode. First, a composition (slurry, paste, etc.) for forming a catalyst layer is prepared by dispersing the above catalyst and optionally the binder or the like in water or an organic solvent. Then, the composition is applied to the surface of the current collector and dried, which is further subjected to pressing (e.g., calendering) as needed.

The catalyst layer may also be a porous carbon sheet made of fibrous carbon such as carbon paper, carbon cloth, or carbon felt. The carbon sheet may also serve as a current collector of the positive electrode, as described below, and can be used as both a catalyst layer and a current collector.

The current collector of the positive electrode having the catalyst layer may be, e.g., a mesh, foil, expanded metal, or punched metal made of metal such as titanium, nickel, stainless steel, or copper or may be, e.g., a mesh or sheet made of carbon. The thickness of the current collector of the positive electrode is preferably 5 μm or more and 300 μm or less, more preferably 10 μm or more, and more preferably 30 μm or less.

Moreover, a part of the resin film constituting the sheet-type outer case may also be used as the current collector of the positive electrode. In such a case, e.g., the current collector can be provided by applying a carbon paste to the surface of the resin film that is to be the inner surface of the sheet-type outer case. Alternatively, when a metal layer is used in combination with the resin film, the metal layer can also serve as the current collector. Then, the catalyst layer can be formed on the surface of the current collector in the same manner as described above, thus producing the positive electrode. The thickness of the carbon paste layer is preferably 30 to 300 μm.

The positive electrode usually has a positive electrode external terminal. The positive electrode external terminal may be formed by connecting, e.g., aluminum foil (plate) or wire or nickel foil (plate) or wire to the current collector of the positive electrode either directly or indirectly via a lead. When the positive electrode external terminal is in the form of foil (plate), the thickness is preferably 50 μm or more and 500 μm or less. When the positive electrode external terminal is in the form of wire, the diameter is preferably 100 μm or more and 1500 μm or less.

Apart of the current collector may be exposed to the outside and used as a positive electrode external terminal.

<Negative Electrode>

The negative electrode of an air cell may contain a metal material. Examples of the metal material include the following: a zinc-based material (which collectively refers to both a zinc material and a zinc alloy material); a magnesium-based material (which collectively refers to both a magnesium material and a magnesium alloy material); and an aluminum-based material (which collectively refers to both an aluminum material and an aluminum alloy material). In this negative electrode, metals such as zinc, magnesium, and aluminum act as an active material.

The alloy constituents of the zinc alloy material may be, e.g., indium (the content is, e.g., 0.005 to 0.05% by mass), bismuth (the content is, e.g., 0.005 to 0.05% by mass), and aluminum (the content is, e.g., 0.001 to 0.15% by mass).

The alloy constituents of the magnesium alloy material may be, e.g., calcium (the content is, e.g. 1 to 3% by mass), manganese (the content is, e.g., 0.1 to 0.5% by mass), zinc (the content is, e.g., 0.4 to 1% by mass), and aluminum (the content is, e.g., 8 to 10% by mass).

The alloy constituents of the aluminum alloy material may be, e.g., zinc (the content is, e.g., 0.5 to 10% by mass), tin (the content is, e.g., 0.04 to 1.0% by mass), gallium (the content is, e.g., 0.003 to 1.0% by mass), silicon (the content is, e.g., 0.05% by mass or less), iron (the content is, e.g., 0.1% by mass or less), magnesium (the content is, e.g., 0.1 to 2.0% by mass), and manganese (the content is, e.g., 0.01 to 0.5% by mass).

In view of a reduction in the environmental impact of the cell for disposal, it is preferable that the metal material used for the negative electrode contains the smallest possible amount of mercury, cadmium, lead, and chromium. Specifically, it is more preferable that the mercury content is 0.1% by mass or less, the cadmium content is 0.01% by mass or less, the lead content is 0.1% by mass or less, and the chromium content is 0.1% by mass or less.

The negative electrode containing the metal material preferably contains an indium compound. The presence of the indium compound in the negative electrode can more effectively prevent the generation of hydrogen gas due to a corrosion reaction between the metal material and the electrolyte solution.

Examples of the indium compound include indium oxide and indium hydroxide.

The amount of the indium compound in the negative electrode is preferably 0.003 to 1 with respect to 100 of the metal material at a mass ratio.

In addition to particles of the above metal materials (i.e., zinc-based particles, magnesium-based particles, and aluminum-based particles), the negative electrode may also be a sheet (metal foil) of the above metal materials such as zinc foil, zinc alloy foil, magnesium foil, or magnesium alloy foil. Such a negative electrode preferably has a thickness of 10 μm or more and 500 μm or less.

The negative electrode containing the metal material may include a current collector as needed. The current collector of the negative electrode may be, e.g., a mesh, foil, expanded metal, or punched metal made of metal that does not react with an electrolyte, such as nickel, copper, stainless steel, or titanium or may be, e.g., a sheet or mesh made of carbon. The thickness of the current collector of the negative electrode is preferably 5 μm or more and 300 μm or less, more preferably 10 μm or more, and more preferably 30 μm or less. In general, copper foil with a thickness of 5 μm or more and 30 μm or less may be preferably used.

The negative electrode containing the metal particles may have a structure in which a negative electrode mixture layer containing, e.g., the metal particles and a binder is formed on one side or both sides of the current collector.

The negative electrode having the negative electrode mixture layer and the current collector can be produced in the following manner. For example, the metal particles and the binder, and optionally a conductive assistant or the like, are dispersed in water or an organic solvent such as NMP to prepare a negative electrode mixture containing composition, e.g., in the form of slurry or paste (in this case, the binder may be dissolved in the solvent). This composition is applied to the current collector, dried, and optionally subjected to pressing such as calendering.

In the composition of the negative electrode mixture layer, e.g., the content of the metal particles is preferably 70 to 99% by mass, and the content of the binder is preferably 1 to 30% by mass. When the conductive assistant is used, the content of the conductive assistant in the negative electrode mixture layer is preferably 1 to 20% by mass. The thickness of the negative electrode mixture layer is preferably 1 to 100 μm (per one side of the current collector).

The current collector of the negative electrode having the negative electrode mixture layer may be the same as described above.

Like the positive electrode, the current collector of the negative electrode can be provided by applying a carbon paste to the surface that is to be the inner surface of the sheet-type outer case. Alternatively, the metal layer of the sheet-type outer case can also serve as the current collector. The thickness of the carbon paste layer is preferably 50 to 200 μm.

Like the positive electrode, the negative electrode usually has a negative electrode external terminal. The negative electrode external terminal may be formed by connecting, e.g., the above metal foil (plate) or wire, which can constitute the current collector of the negative electrode, to the current collector of the negative electrode either directly or indirectly via a lead. When the negative electrode external terminal is in the form of foil (plate), the thickness is preferably 20 μm or more and 500 μm or less. When the negative electrode external terminal is in the form of wire, the diameter is preferably 50 μm or more and 1500 μm or less.

Moreover, when the negative electrode is a metal sheet such as a zinc-based sheet or a magnesium-based sheet, a part of the metal sheet may be used as a lead of the negative electrode and connected to an external terminal, or may also be used as the external terminal.

<Separator>

The separator is interposed between the positive electrode and the negative electrode. Examples of the separator include the following: a nonwoven fabric mainly composed of vinylon and rayon; a vinylon-rayon nonwoven fabric (vinylon-rayon mixed paper); a polyamide nonwoven fabric; a polyolefin-rayon nonwoven fabric; vinylon paper; vinylon-linter pulp paper; and vinylon-mercerized pulp paper. Moreover, the separator may be a laminate of a hydrophilic microporous polyolefin film (such as a microporous polyethylene film or a microporous polypropylene film), a cellophane film, and a liquid-absorbing layer (i.e., an electrolyte holding layer) such as vinylon-rayon mixed paper. The thickness of the separator is preferably 20 to 500 μm.

The separator is preferably a cellophane film when the pH of an aqueous solution (electrolyte solution) used as the electrolyte is 3 or more and less than 12, as will be described later. The electrolyte solution with a pH of 3 or more and less than 12 is superior to a strong alkaline aqueous solution (with a pH of about 14) such as a potassium hydroxide aqueous solution, which has generally been used as an electrolyte solution, in reducing the environmental impact of the air cell, but significantly impairs the discharge characteristics. However, the use of the cellophane film as the separator between the positive electrode and the negative electrode in the air cell containing the electrolyte solution with a pH of 3 or more and less than 12 can improve the discharge capacity and the discharge voltage, and thus can ensure the discharge characteristics at a practical level, as compared to the air cell that does not include the cellophane film.

When the cellophane film is used as the separator, the separator may consist only of the cellophane film. However, the cellophane film can easily be damaged during cell assembly because of its low strength. Therefore, it is also recommended that the separator should be made of a laminated material of the cellophane film and a grafted film of a particular polymer.

<Electrolyte>

The electrolyte is an aqueous solution (electrolyte solution) in which an electrolyte salt or the like is dissolved in water. Examples of the electrolyte salt include the following: chlorides such as sodium chloride, potassium chloride, magnesium chloride, calcium chloride, ammonium chloride, and zinc chloride; hydroxides of alkali metals or alkaline-earth metals (e.g., sodium hydroxide, potassium hydroxide, and magnesium hydroxide), acetates of alkali metals or alkaline-earth metals (e.g., sodium acetate, potassium acetate, and magnesium acetate), nitrates of alkali metals or alkaline-earth metals (e.g., sodium nitrate, potassium nitrate, and magnesium nitrate), sulfates of alkali metals or alkaline-earth metals (e.g., sodium sulfate, potassium sulfate, and magnesium sulfate), phosphates of alkali metals or alkaline-earth metals (e.g., sodium phosphate, potassium phosphate, and magnesium phosphate), borates of alkali metals or alkaline-earth metals (e.g., sodium borate, potassium borate, and magnesium borate), citrates of alkali metals or alkaline-earth metals (e.g., sodium citrate, potassium citrate, and magnesium citrate), and glutamates of alkali metals or alkaline-earth metals (e.g., sodium glutamate, potassium glutamate, and magnesium glutamate); hydrogencarbonates of alkali metals (e.g., sodium hydrogencarbonate and potassium hydrogencarbonate); percarbonates of alkali metals (e.g., sodium percarbonate and potassium percarbonate); compounds containing halogens such as fluorides; and polycarboxylic acids. The electrolyte may contain either one or two or more of these electrolyte salts.

The pH of the electrolyte is preferably 3 or more and less than 12 in terms of reducing the environmental impact of the cell for disposal. Some electrolyte salts may affect the pH when dissolved in the aqueous solution that is to be the electrolyte. It is preferable that the concentration of such electrolyte salts is adjusted so that the pH of the electrolyte falls in the above range.

The electrolyte is more preferably an aqueous solution of chloride such as a sodium chloride aqueous solution. For example, when the electrolyte is a sodium chloride aqueous solution, the concentration of sodium chloride is preferably 1 to 23% by mass.

In the air cell, the composition of the electrolyte is likely to change because water in the electrolyte may be vaporized and dissipated through the air holes. To avoid this problem, a water-soluble high-boiling solvent with a boiling point of 150° C. or more (preferably 320° C. or less) may be used with water as a solvent of the electrolyte, or the electrolyte containing the aqueous solution may be mixed with a thickening agent (more preferably to form a gel (gel electrolyte)).

Examples of the water-soluble high-boiling solvent include the following: polyhydric alcohols such as ethylene glycol (boiling point: 197° C.), propylene glycol (boiling point: 188° C.), and glycerol (boiling point: 290° C.); and polyalkylene glycol (having a molecular weight of preferably 600 or less) such as polyethylene glycol (PEG, e.g., boiling point: 230° C.). The content of the water-soluble high-boiling solvent is preferably 3 to 30% by mass of the total solvent.

When the negative electrode is metal foil such as a zinc-based sheet or a magnesium-based sheet, the negative electrode can be broken due to corrosion by the electrolyte solution (aqueous solution), and the capacity of the negative electrode cannot be drawn sufficiently. However, the electrolyte containing the aqueous solution is more preferably turned into a gel (gel electrolyte) by the addition of the thickening agent. This configuration can reduce the above problem as well as avoiding the problem of the composition change of the electrolyte. The thickening agent to be mixed with the electrolyte may be any of various synthetic polymers or natural polymers. Specific examples of the thickening agent include the following: cellulose derivatives such as carboxymethyl cellulose (CMC) and carboxyethyl cellulose (CEC); polyalkylene glycol (having a molecular weight of preferably 1000 or more, and more preferably 10000 or more) such as polyethylene glycol (PEG); polyvinylpyrrolidone; polyvinyl acetate; starch; guar gum; xanthan gum; sodium alginate; hyaluronic acid; gelatin; and polyacrylic acid. Among these thickening agents, when the functional group including a carboxyl group or its salt (—COOH, —COONa, etc.) is present in the molecule, it is also preferable that a polyvalent metal salt serving as a gelation accelerator is added to the electrolyte. The content of the thickening agent in the electrolyte is preferably 0.1 to 5% by mass. When the gelation accelerator is added to the electrolyte, the content of the gelation accelerator is preferably 1 to 30 with respect to 100 of the thickening agent at a mass ratio.

As described above, the water repellent membrane is placed between the positive electrode and the outer case. The water repellent membrane has not only water repellency, but also air permeability. Specific examples of the water repellent membrane include a membrane made of resin, e.g., fluororesin such as PTFE or polyolefins such as polypropylene and polyethylene. The thickness of the water repellent membrane is preferably 50 to 250 μm.

An air diffusion membrane may be provided between the outer case and the water repellent membrane. The air diffusion membrane serves to supply the air that has been introduced into the outer case to the positive electrode. The air diffusion membrane may be, e.g., a nonwoven fabric made of resin such as cellulose, polyvinyl alcohol, polypropylene, or nylon. The thickness of the air diffusion membrane is preferably 100 to 250 μm.

The cells in the cell roll of this embodiment are suitable, because of their form, as a power source for medical and health equipment such as a wearable patch, in particular a patch that can be attached to the surface of the skin to measure information about body conditions, including body temperature, pulse, and perspiration. In view of the possibility that the electrolyte may leak to the outside due to damage to the cell, the cells in the cell roll of this embodiment are preferably air cells in which the electrolyte is an electrolyte solution containing water as a solvent (i.e., the electrolyte is an aqueous solution), since the air sells have higher safety particularly when used for the purposes described above. Moreover, alkaline cells or manganese cells including the same electrolyte solution as the air cells can also be preferably used.

Next, the sheet-type outer case body of the cell roll of this embodiment will be described. The sheet-type outer case body may be made of, e.g., a resin film. Examples of the resin film include a nylon film (such as a nylon 66 film) and a polyester film (such as a polyethylene terephthalate (PET) film).

The sheet-type outer case body is generally sealed by heat-sealing the edges of the upper resin film and the lower resin film of the sheet-type outer case body. To further facilitate the heat seal, a heat-sealing resin layer may be formed on the resin film and used as the sheet-type outer case body. The heat-sealing resin of the heat-sealing resin layer may be, e.g., a modified polyolefin (such as a modified polyolefin ionomer) or polypropylene and its copolymer. The thickness of the heat-sealing resin layer is preferably 20 to 200 μm.

Moreover, a metal layer may be formed on the resin film. The metal layer may be, e.g., an aluminum film (including aluminum foil and aluminum alloy foil) or a stainless steel film (including stainless steel foil). The thickness of the metal layer is preferably 10 to 150 μm.

The resin film of the sheet-type outer case body may be formed of e.g., a laminated material of the heat-sealing resin layer and the metal layer.

The resin film of the sheet-type outer case body preferably has an electrically insulating moisture barrier layer. In this case, the resin film may have either a single layer structure or a multilayer structure. The single layer structure includes an electrically insulating resin film that also serves as a moisture barrier layer. The multilayer structure includes a plurality of electrically insulating resin films, at least one of which serves as a moisture barrier layer. Alternatively, the multilayer structure may include a base material layer made of a resin film and an electrically insulating moisture barrier layer formed on the surface of the base material layer.

The preferred resin film has a structure in which the moisture barrier layer composed of at least an inorganic oxide is formed on the surface of the base material layer made of a resin film.

Examples of the inorganic oxide of the moisture barrier layer include aluminum oxide and silicon oxide. The moisture barrier layer composed of silicon oxide tends to be superior to that composed of aluminum oxide in the function of reducing the permeation of water contained in the electrolyte solution of the cell. For this reason, the inorganic oxide of the moisture barrier layer is more preferably silicon oxide.

The moisture barrier layer composed of the inorganic oxide can be formed on the surface of the base material layer by, e.g., an evaporation method. The thickness of the moisture barrier layer is preferably 10 to 300 nm.

Examples of the base material layer that is made of a resin film and provided with the moisture barrier layer include the nylon film and the polyester film, as described above. Moreover, the base material layer may be, e.g., a polyolefin film, a polyimide film, or a polycarbonate film. The thickness of the base material layer is preferably 5 to 100 μm.

When the resin film includes the moisture barrier layer and the base material layer, a protective layer for protecting the moisture barrier layer may be formed on the surface of the moisture barrier layer (which is opposite to the base material layer).

The resin film including the moisture barrier layer and the base material layer may further include the heat-sealing resin layer.

The total thickness of the sheet-type outer case body is preferably 10 μm or more in terms of, e.g., imparting sufficient strength to the sheet-type cell and 200 μm or less in terms of reducing an increase in the thickness of the sheet-type cell and a decrease in the energy density of the sheet-type cell.

The moisture permeability of the resin film of the sheet-type outer case body is preferably 10 g/m²·24 h or less. It is desirable that the resin film is not permeable to moisture as much as possible. In other words, the moisture permeability of the resin film is preferably as small as possible and may be 0 g/m²·24 h.

In the present specification, the moisture permeability of the resin film is a value measured by a method in accordance with JIS K 7129B.

When the cells in the cell roll of this embodiment are air cells, it is preferable that the resin film of the sheet-type outer case body has some degree of oxygen permeability. The air cells are discharged by supplying air (oxygen) to the positive electrode. Therefore, the sheet-type outer case body has air holes through which oxygen is introduced into the cells. If the resin film of the sheet-type outer case body is permeable to oxygen, the oxygen can be introduced into each cell not only through the air holes, but also through the portion of the sheet-type outer case other than the air holes. As a result, the oxygen can be supplied more uniformly over the entire positive electrode. Thus, the discharge characteristics of the cells can be improved and the discharge time can be made longer. It is also possible to provide a sheet-type air cell that has a sheet-type outer case without air holes.

The specific oxygen permeability of the resin film of the sheet-type outer case body for the air cells is preferably 0.02 cm³/m²·24 h·MPa or more, and more preferably 0.2 cm³/m²·24 h·MPa or more. However, if the resin film of the sheet-type outer case body for the air cells allows too much oxygen to pass through it, self-discharge may occur, leading to the loss of capacity. Therefore, the oxygen permeability of the resin film is preferably 100 cm³/m²·24 h·MPa or less, and more preferably 50 cm³/m²·24 h·MPa or less.

On the other hand, when the cells in the cell roll are other than the air cells, the oxygen permeability of the resin film of the sheet-type outer case body is not particularly limited. However, it is preferable that the resin film is not much permeable to oxygen in terms of improving the storage characteristics of the cells. The specific oxygen permeability of the resin film is preferably 10 cm³/m²·24 h·MPa or less.

In the present specification, the oxygen permeability of the resin film is a value measured by a method in accordance with JIS K 7126-2.

The thickness of the cells in the cell roll (represented by “a” in FIG. 2) is not particularly limited and may be appropriately changed depending on the use of the individual cells. One of the advantages of the cell having the sheet-type outer case (i.e., the sheet-type cell) is that the thickness can be reduced. In view of this, the thickness of the cells in the cell roll is preferably, e.g., 1 mm or less. It is particularly easy for the air cells to have such a small thickness.

The lower limit of the thickness of the cells in the cell roll is not particularly limited and may usually be 0.2 mm or more to maintain a predetermined amount of capacity.

Each cell obtained from the cell roll of this embodiment is a sheet-type cell having a sheet-type outer case. The sheet-type cell can be used in the same applications as those of conventionally known various sheet-type cells. As described above, the sheet-type cell is particularly suitable as a power source for medical and health equipment, e.g., a wearable patch such as a patch that can be attached to the surface of the skin to measure information about body conditions, including body temperature, pulse, and perspiration.

### EXAMPLES

Hereinafter, the cell roll disclosed in the present application will be described in detail based on examples. However, the cell roll is not limited to the following examples.

### Example 1

<Positive Electrode>

Porous carbon paper (thickness: 0.25 mm, porosity: 75%, air permeability (Gurley): 70 sec/100 ml) was used as a positive electrode (air electrode).

<Negative Electrode>

Zinc alloy foil (thickness: 0.05 mm) containing 0.04% by mass of Bi as an additional element was used as a negative electrode.

<Separator>

A laminated film was produced by forming two graft films (each having a thickness of 15 μm) on both sides of a cellophane film (having a thickness of 20 μm). The graft films were composed of a graft copolymer obtained by graft copolymerization of acrylic acid with a polyethylene main chain. This laminated film (having a total thickness of 50 μm) was used as a separator.

<Electrolyte Solution>

An ammonium sulfate aqueous solution with a concentration of 20% by mass was used as an electrolyte solution.

<Water Repellent Membrane>

A PTFE sheet with a thickness of 200 μm was used as a water repellent membrane.

<Outer Case Member>

Outer case members for the positive electrode and the negative electrode were both made of an aluminum laminated film (thickness: 65 μm) having a structure in which a PET film was provided on the outer surface of aluminum foil and a polypropylene film (heat-sealing resin layer) was provided on the inner surface of the aluminum foil.

<Cell Assembly>

Nine air holes, each having a diameter of 1 mm, were regularly formed in the outer case member that had been unwound from a roll. This outer case member was to be located near the positive electrode. The air holes were arranged at regular intervals of 9 mm (length)×9 mm (width) (i.e., the center-to-center distance of adjacent air holes: 10 mm). Then, a hot-melt adhesive was applied to the inner surface of the outer case member. Next, the PTFE sheet was fed from a roll and cut to a size of 40 mm×40 mm. The PTFE sheet was formed on the surface coated with the hot-melt adhesive and thermally fused to the surface by heating and pressing, so that the water repellent membrane was provided.

The carbon paper was fed from a roll and punched into a shape including a catalyst layer with a size of 30 mm×30 mm and a lead with a size of 5 mm×15 mm. The lead was placed at one end of the catalyst layer. Thus, the positive electrode was provided and formed on the water repellent membrane. Moreover, the separator was fed from a roll and cut to a size of 40 mm×40 mm. The separator was formed on the positive electrode.

Next, the zinc alloy foil was fed from a roll and punched into a shape including a portion functioning as an active material with a size of 30 mm×30 mm and a lead with a size of 5 mm×15 mm. The lead was placed at one end of the portion. Thus, the negative electrode was provided and formed on the separator so that the lead of the negative electrode was located on the same side as the lead of the positive electrode.

In the outer case member that had been unwound from a roll and was to be located near the negative electrode, a modified polyolefin ionomer film was attached in parallel with the side of the outer case member to a portion that would face the leads of the positive electrode and the negative electrode in order to improve the sealing properties of the thermally fused portion between the leads and the outer case member.

Next, the outer case member for the negative electrode was formed on the negative electrode. Then, three sides of the two outer case members, i.e., one side on which the leads of the positive electrode and the negative electrode were located and two sides next to this side were sealed by thermally fusing their edges together. The resulting product was wound into a roll of the sheet-type continuous body in which the layered bodies, each including the water repellent membrane, the positive electrode, the separator, and the negative electrode, were disposed between the outer case members and located side by side in the longitudinal direction.

In the roll of the sheet-type continuous body, the portion opposite to the side on which the leads of the positive electrode and the negative electrode were located had not been sealed, but was open to receive the electrolyte solution. The roll was placed with the openings facing up, and then the sheet-type continuous body was unwound. Further, the electrolyte solution was injected through the openings, and subsequently the openings were thermally fused and sealed. Thus, the sheet-type continuous body of cells with a length of 300 m was produced. The sheet-type continuous body included a long sheet-type outer case body made of a resin film, and the power generation elements, each including the positive electrode, the negative electrode, the separator, and the electrolyte (electrolyte solution), were individually sealed in the sheet-type outer case body. The outer case of each of the cells had a size of 50 mm×50 mm.

The sheet-type continuous body was wound around a winding core made of ABS resin and having a diameter of 100 mm so that the air holes of the individual air cells faced inward, resulting in a cell roll.

<Storage Test>

A cell at the end of the outermost loop of the cell roll thus produced was cut from the sheet-type continuous body. The cell was connected to a discharge resistance of 0.75 kΩ and discharged at room temperature. The discharge capacity (i.e., the capacity before storage) of the cell was measured until the cell voltage was reduced to 0.5 V.

Next, the end of the outermost loop after the cell had been removed was fixed with an adhesive tape so as to prevent loosening of the cell roll. Then, a storage test was performed in such a manner that the cell roll was stored in an environment of 40° C. for 14 days.

After the storage test, the sheet-type continuous body of the cell roll was rewound, and a cell located 150 m inward from the end of the outermost loop (i.e., the 3001st cell from the end of the outermost loop) was cut from the sheet-type continuous body. The discharge capacity (i.e., the capacity after storage) of the cell was measured at room temperature in the same manner as described above. Thus, the ratio of the capacity after storage to the capacity before storage (i.e., the capacity retention rate) was determined.

### Example 2

A cell roll was produced in the same manner as Example 1 except that the sheet-type continuous body was wound around the winding core of ABS resin together with a 30 μm thick ethylene-vinyl alcohol copolymer film, and the air holes formed in the outer case member for the positive electrode were covered with the film.

A storage test was performed on the cell roll thus produced in the same manner as Example 1. The capacity retention rate of the cell after the storage test was determined in the same manner as Example 1.

### Comparative Example 1

One cell was cut from the sheet-type continuous body that was produced in the same manner as Example 1. The separate cell was used alone without closing the air holes with a seal and subjected to a storage test in an environment of 40° C. for 14 days. After the storage test, the capacity after storage of the cell was measured in the same manner as Example 1. Then, the capacity retention rate was determined by comparing the resulting capacity after storage with the capacity before storage measured in Example 1.

Table 1 shows the measurement results of the capacity retention rate of the cells in the storage test.

TABLE 1

| | Capacity retention rate (%) |
|---|---|
| Example 1 | 75 |
| Example 2 | 90 |
| Comparative Example 1 | 20 |

In Examples 1 and 2, the sheet-type continuous body was wound to form the cell roll. Therefore, the cells of Examples 1 and 2 were able to reduce the inflow of air during storage without using a seal and improve the capacity retention rate, as compared to the cell of Comparative Example 1, which was the same as the conventional cell. In Example 2, since the resin sheet was inserted in the winding of the sheet-type continuous body, the air holes for the positive electrode were more properly closed with the resin sheet. Thus, the capacity retention rate of the cell obtained from the cell roll of Example 2 was more improved than that of the cell obtained from the cell roll of Example 1.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

### DESCRIPTION OF REFERENCE NUMERALS

1 Air cell (sheet-type cell)
20 Positive electrode
20a Positive electrode external terminal
30 Negative electrode
30a Negative electrode external terminal
40 Separator
50 Water repellent membrane
60 Sheet-type outer case body
61 Air hole
100 Cell roll
100a Sheet-type continuous body of cells

1. A cell roll comprising:
a sheet-type continuous body comprising a long sheet-type outer case body and a plurality of power generation elements,
wherein the sheet-type outer case body includes a resin film,
the power generation elements are individually sealed in the sheet-type outer case body,
the power generation elements are located side by side in a longitudinal direction of the sheet-type outer case body,
each of the power generation elements includes a positive electrode, a negative electrode, a separator, and an electrolyte,
the sheet-type outer case body and the power generation elements form individual cells, and
the sheet-type continuous body is wound in a spiral fashion.

2. The cell roll according to claim 1, wherein the power generation elements are located in a row in the longitudinal direction of the sheet-type outer case body.

3. The cell roll according to claim 1, wherein the individual cells are configured to be easily cut off.

4. The cell roll according to claim 1, wherein the negative electrode includes metal foil with a thickness of 10 μm or more and 500 μm or less.

5. The cell roll according to claim 4, wherein a part of the metal foil constitutes a lead of the negative electrode.

6. The cell roll according to claim 1, wherein the cells are air cells, each having an air electrode as the positive electrode and air holes in the sheet-type outer case body.

7. The cell roll according to claim 6, wherein the sheet-type continuous body is wound in a spiral fashion with a resin sheet being on a surface of the sheet-type outer case body where the air holes are provided.

8. The cell roll according to claim 1, wherein the resin film includes an electrically insulating moisture barrier layer.

9. A method for producing the cell roll according to claim 1,
the method comprising:
forming the negative electrode by supplying metal foil with a thickness of 10 μm or more and 500 μm or less and cutting the metal foil to a predetermined shape having a lead;
forming the sheet-type continuous body by sealing power generation elements in the sheet-type outer case body, each of the power generation elements including the electrolyte and a layered body in which the positive electrode, the separator, and the negative electrode are sequentially stacked; and
winding the sheet-type continuous body in a spiral fashion to form a cell roll.

10. The cell roll according to claim 4, wherein a part of the metal foil constitutes an external terminal of the negative electrode.

11. The cell roll according to claim 6, wherein the positive electrode has a porous carbon sheet.

12. The cell roll according to claim 11, wherein a part of the carbon sheet constitutes an external terminal of the positive electrode.
